(19) United States
(12) Patent Application Publication
(10) Pub. No.: US 2020/0152060 A1
(43) Pub. Date: May 14, 2020

(54) UNDERGROUND GARAGE PARKING SPACE EXTRACTION METHOD AND SYSTEM FOR HIGH-DEFINITION MAP MAKING

(71) Applicant: WUHHAN KOTEL BIG DATE CORPORATION, Wuhan, Hubei (CN)

(72) Inventors: Cheng ZHANG, Wuhan (CN); Yewei LI, Wuhan (CN); Yuejun LUO, Wuhan (CN)

(73) Assignee: WUHHAN KOTEL BIG DATE CORPORATION, Wuhan,Hubei (CN)

(21) Appl. No.: 16/618,440

(22) PCT Filed: May 14, 2019
(86) PCT No.: PCT/CN2019/086895

§ 371 Date: Dec. 2, 2019

(30) Foreign Application Priority Data
Sep. 5, 2018 (CN) 201811033589.X

(51) Int. Cl. G08G 1/14; G01C 21/36; G06K 9/00; G06K 9/62

(52) U.S. Cl. CPC G08G 1/141; G08G 1/145; G01C 21/3685; G06K 9/6277; G06K 9/00812; G06K 9/6202; G06K 9/0063

(57) ABSTRACT

The embodiments of the application provide an underground garage parking space extraction method and system for high-definition map making. The method includes that: Three-Dimensional (3D) laser point cloud data including a parking space is obtained, and the 3D laser point cloud data is projected into a Two-Dimensional (2D) aerial mode image; a contrast estimate index of the 2D aerial mode image is determined, and image preprocessing is performed on the 2D aerial mode image according to the contrast estimate index to obtain a binary image; line segments of the binary image is detected, and a parking line rotation angle of the parking space is determined according to a detection result; the binary image is rotated by taking a center point of the binary image as a circle center according to the parking line rotation angle to obtain a rotated image; pixels of parking lines in each row and pixels of parking lines in each column in the rotated image are counted to obtain integral projections in horizontal and vertical directions respectively; coordinates of four internal angular points corresponding to the parking space are obtained by searching according to the integral projection in the horizontal direction and the integral projection in the vertical direction; and the coordinates of the four internal angular points are inversely transformed to point cloud data to extract the parking space.

### CROSS-REFERENCE TO RELATED APPLICATIONS

The present disclosure is filed based upon and claims priority to Chinese Patent Application No. 201811033589.X, filed on Sep. 5, 2018, the contents of which are hereby incorporated by reference in its entirety.

### TECHNICAL FIELD

The disclosure relates to the technical field of high-definition map making, and more particularly to an underground garage parking space extraction method and system for high-definition map making.

### BACKGROUND

High-definition map is one of core self-driving technologies. An accurate map is essential for positioning, navigation and control of a self-driving car as well as safety. How to generate a high-definition map is also a problem urgent to be solved in the field of self-driving. An underground garage parking space refers to a region built underground for parking a motor vehicle for a long time or temporarily, and a parking region for each vehicle is divided by parking lines according to a certain size. Underground garages are matched with different grades of urban roads, meet parking requirements of different scales and play a very important role in regulation and control over the traffic of urban centers. As an important part of a high-definition map, high-accuracy underground garage parking space data is particularly important.

An existing parking space extraction method is usually an original image data-based extraction method. An edge detection method is adopted to perform edge detection to obtain an edge point set of parking lines, and then Hough transform and line extraction are performed on the edge point set to extract the parking lines to obtain a final parking space.

However, the method is sensitive to light, and a gradient of the parking space in an image is greatly different under different lighting conditions, which may easily result in mistaken extraction and missing extraction. Meanwhile, in a practical application, the edge point set obtained by the edge detection method may not only form edges of the parking lines but also include a noise and an error rate may be high if only Hough transform and line extraction are adopted, so that extraction accuracy is not so high and may not meet an accuracy requirement of the high-definition map.

### SUMMARY

Embodiments of the disclosure are expected to disclose an underground garage parking space extraction method and system for high-definition map making.

The embodiments of the disclosure provide an underground garage parking space extraction method for high-definition map making, which may include the following operations.

Three-Dimensional (3D) laser point cloud data including a parking space is obtained, and the 3D laser point cloud data is projected into a Two-Dimensional (2D) aerial mode image. A contrast estimate index of the 2D aerial mode image is determined, and image preprocessing is performed on the 2D aerial mode image according to the contrast estimate index to obtain a binary image. Line segments of the binary image is detected, and a parking line rotation angle of the parking space is determined according to a detection result. The binary image is rotated by taking a center point of the binary image as a circle center according to the parking line rotation angle to obtain a rotated image. Pixels of parking lines in each row and pixels of parking lines in each column in the rotated image are counted to obtain integral projections in horizontal and vertical directions respectively. Coordinates of four internal angular points corresponding to the parking space are obtained by searching according to the integral projection in the horizontal direction and the integral projection in the vertical direction. The coordinates of the four internal angular points are inversely transformed to point cloud data to extract the parking space.

In the underground garage parking space extraction method for high-definition map making according to the embodiments of the disclosure, the operation that the contrast estimate index of the 2D aerial mode image is determined and image preprocessing is performed on the 2D aerial mode image according to the contrast estimate index to obtain the binary image may include the following operations.

A contrast of the 2D aerial mode image is estimated by use of an image standard deviation, the contrast satisfying e=std(I).

I may represent the 2D aerial mode image, and e may represent the contrast.

The contrast is compared with a given threshold value to obtain a comparison result.

Under the circumstance that the comparison result is that the contrast is less than a first threshold value, median filtering processing, Gaussian adaptive binarization processing and morphological closing processing are sequentially performed on the 2D aerial mode image to obtain the binary image.

Under the circumstance that the comparison result is that the contrast is more than or equal to the first threshold value, morphological closing processing, local Laplace filtering processing and Gaussian adaptive binarization processing are sequentially performed on the 2D aerial mode image to obtain the binary image.

In the underground garage parking space extraction method for high-definition map making according to the embodiments of the disclosure, the operation that the line segment of the binary image is detected and the parking line rotation angle of the parking space is determined according to the detection result may include that: probability Hough transform is performed to detect a line segment set, with a parking line directivity, of the binary image, and the line segment set is traversed to obtain a line segment subset in which a length of each line segment is more than a first threshold value and an included angle between each line segment and a specific direction satisfies a preset condition; and the line segment length and inclination angle in the line segment subset are calculated, and the parking line rotation angle of the parking space is determined according to the line segment length and the inclination angle.

In the underground garage parking space extraction method for high-definition map making according to the embodiments of the disclosure, the operation that the binary image is rotated by taking the center point of the binary image as the circle center according to the parking line rotation angle may include that: the binary image is rotated by taking the parking line rotation angle as a rotation angle and taking the center point of the binary image as the circle center, the parking lines in the obtained rotated image being parallel or perpendicular to the horizontal direction.

In the underground garage parking space extraction method for high-definition map making according to the embodiments of the disclosure, the operation that the pixels of the parking lines in each row and each column in the rotated image are counted to obtain the integral projections in the horizontal and vertical directions respectively may include that: the number of the pixels of the parking lines in each column in the rotated image and the number of the pixels of the parking lines in each row in the rotated image are determined respectively to obtain one-dimensional vector representing the horizontal integral projection and one-dimensional vector representing vertical integral projection respectively.

In the underground garage parking space extraction method for high-definition map making according to the embodiments of the disclosure, the operation that the coordinates of the four internal angular points of the parking space are obtained by searching according to the integral projection in the horizontal direction and the integral projection in the vertical direction may include that: first elements of which indexes correspond to gray values greater than a second threshold value are searched along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively; and four intersection coordinates corresponding to the parking space in the rotated image are obtained based on the element indexes i, j, m and n.

In the underground garage parking space extraction method for high-definition map making according to the embodiments of the disclosure, the operation that the coordinates of the four internal angular points are inversely transformed to point cloud data to extract the parking space may include that: inverse rotation transform is performed by taking a center point of the rotated image as a circle center according to the parking space rotation angle to project the coordinates of the four internal angular points to an input point cloud by inverse transform to extract the parking space.

The embodiments of the disclosure also provide an underground garage parking space extraction system for high-definition map making, which may include a projection unit, a contrast estimation unit, an angle estimation unit, a rotation unit, a counting unit, a coordinate searching unit and a parking space extraction unit.

The projection unit may be configured to obtain 3D laser point cloud data including a parking space and project the 3D laser point cloud data into a 2D aerial mode image.

The contrast estimation unit may be configured to determine a contrast estimate index of the 2D aerial mode image and perform image preprocessing on the 2D aerial mode image according to the contrast estimate index to obtain a binary image.

The angle estimation unit may be configured to detect line segments of the binary image and determine a parking line rotation angle of the parking space according to a detection result.

The rotation unit may be configured to rotate the binary image by taking a center point of the binary image as a circle center according to the parking line rotation angle to obtain a rotated image.

The counting unit may be configured to count pixels of parking lines in each row and pixels of parking lines in each column in the rotated image to obtain integral projections in horizontal and vertical directions respectively.

The coordinate searching unit may be configured to obtain coordinates of four internal angular points corresponding to the parking space by searching according to the integral projection in the horizontal direction and the integral projection in the vertical direction.

The parking space extraction unit may be configured to inversely transform the coordinates of the four internal angular points to point cloud data to extract the parking space.

In the underground garage parking space extraction system for high-definition map making according to the embodiments of the disclosure, the contrast estimation unit may be configured to estimate a contrast of the 2D aerial mode image by use of an image standard deviation, the contrast satisfying e=std(I), where I may represent the 2D aerial mode image and e may represent the contrast, compare the contrast and a given threshold value to obtain a comparison result, under the circumstance that the comparison result is that the contrast is less than a first threshold value, sequentially perform median filtering processing, Gaussian adaptive binarization processing and morphological closing processing on the 2D aerial mode image to obtain the binary image, and under the circumstance that the comparison result is that the contrast is more than or equal to the first threshold value, sequentially perform morphological closing processing, local Laplace filtering processing and Gaussian adaptive binarization processing on the 2D aerial mode image to obtain the binary image.

In the underground garage parking space extraction system for high-definition map making according to the embodiments of the disclosure, the angle estimation unit may be configured to perform probability Hough transform to detect a line segment set, with a parking line directivity, of the binary image, traverse the line segment set to obtain a line segment subset in which a length of each line segment is more than a first threshold value and an included angle between each line segment and a specific direction satisfies a preset condition, calculate the line segment length and inclination angle in the line segment subset and determine the parking line rotation angle of the parking space according to the line segment length and the inclination angle.

In the underground garage parking space extraction system for high-definition map making according to the embodiments of the disclosure, the rotation unit may be configured to rotate the binary image by taking the parking line rotation angle as a rotation angle and taking the center point of the binary image as the circle center, the parking lines in the obtained rotated image being parallel or perpendicular to the horizontal direction.

In the underground garage parking space extraction system for high-definition map making according to the embodiments of the disclosure, the counting unit may be configured to determine the number of the pixels of the parking lines in each column in the rotated image and the number of the pixels of the parking lines in each row in the rotated image to obtain one-dimensional vector representing the horizontal integral projection and one-dimensional vector representing vertical integral projection respectively.

In the underground garage parking space extraction system for high-definition map making according to the embodiments of the disclosure, the coordinate searching unit may be configured to search first elements of which indexes correspond to gray values greater than a second threshold value along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively, and obtain four intersection coordinates corresponding to the parking space in the rotated image based on the element indexes i, j, m and n.

In the underground garage parking space extraction system for high-definition map making according to the embodiments of the disclosure, the parking space extraction unit may be configured to perform inverse rotation transform by taking a center point of the rotated image as a circle center according to the parking space rotation angle to project the coordinates of the four internal angular points to an input point cloud by inverse transform to extract the parking space.

The embodiments of the disclosure also provide an underground garage parking space extraction system for high-definition map making, which may include a processor and a memory configured to store a computer program capable of running in the processor, the processor being configured to run the computer program to execute the steps of the method of the embodiments of the disclosure.

The embodiments of the disclosure also provide a computer-readable storage medium, in which a computer program may be stored, the computer program being executed by a processor to implement the steps of the method of the embodiments of the disclosure.

According to the underground garage parking space extraction method and system for high-definition map making in the embodiments of the disclosure, the 3D point cloud data is taken as input, the data is obtained by a laser scanner, and the laser scanner is an active light source, so that influence of light is avoided. Different image preprocessing methods are used according to image quality assessments, so that algorithm robustness is improved. The inclination angle in the image is detected by improved probability Hough transform, so that consistency of detection and a detection object is improved. The intersection coordinates of the parking lines are calculated by use of a projected image rotation method to extract the parking space, so that accuracy of extracted parking space data may be effectively ensured, and a requirement on making accuracy of a high-definition map may be met.

### BRIEF DESCRIPTION OF DRAWINGS

FIG. 1 is a flowchart of an underground garage parking space extraction method for high-definition map making.

### DETAILED DESCRIPTION

The disclosure will further be described below in combination with the drawings and specific embodiments in detail.

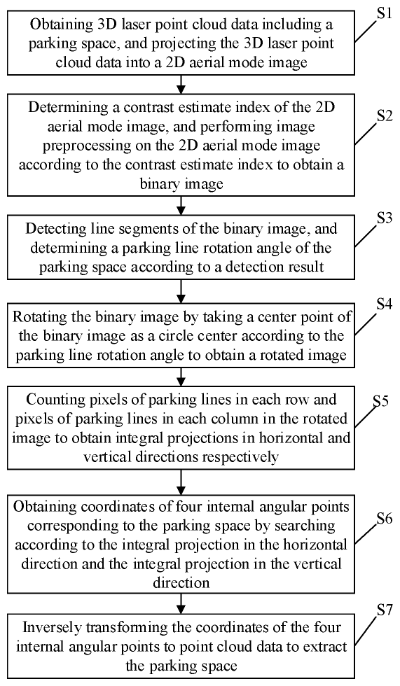

An embodiment of the disclosure provides an underground garage parking space extraction method for high-definition map making. As shown in FIG. 1, the method includes the following steps.

In S1, 3D laser point cloud data including a parking space is obtained, and the 3D laser point cloud data is projected into a 2D aerial mode image.

In S2, a contrast estimate index of the 2D aerial mode image is determined, and image preprocessing is performed on the 2D aerial mode image according to the contrast estimate index to obtain a binary image.

In S3, line segments of the binary image is detected, and a parking line rotation angle of the parking space is determined according to a detection result.

In S4, the binary image is rotated by taking a center point of the binary image as a circle center according to the parking line rotation angle to obtain a rotated image.

In S5, pixels of parking lines in each row and pixels of parking lines in each column in the rotated image are counted to obtain integral projections in horizontal and vertical directions respectively.

In S6, coordinates of four internal angular points corresponding to the parking space are obtained by searching according to the integral projection in the horizontal direction and the integral projection in the vertical direction.

In S7, the coordinates of the four internal angular points are inversely transformed to point cloud data to extract the parking space.

A high-definition map represents a lane-based map formed by topological network elements and, compared with a conventional map, is more accurate in geographical information.

In the underground garage parking space extraction method for high-definition map making according to the embodiment of the disclosure, the operation that the contrast estimate index of the 2D aerial mode image is determined and image preprocessing is performed on the 2D aerial mode image according to the contrast estimate index to obtain the binary image includes the following operations.

A contrast of the 2D aerial mode image is estimated by use of an image standard deviation, the contrast satisfying e=std(I), where I represents the 2D aerial mode image, e represents the contrast, and std( )represents estimation processing with the image standard deviation. The contrast is compared with a given threshold value to obtain a comparison result. Under the circumstance that the comparison result is that the contrast is less than a first threshold value, median filtering processing, Gaussian adaptive binarization processing and morphological closing processing are sequentially performed on the 2D aerial mode image to obtain the binary image. Under the circumstance that the comparison result is that the contrast is more than or equal to the first threshold value, morphological closing processing, local Laplace filtering processing and Gaussian adaptive binarization processing are sequentially performed on the 2D aerial mode image to obtain the binary image.

As an example, the binary image meets the following expression:

$${I}_{b} = \{ \begin{matrix}close ( g B ( mediaBlur ( I ) ) ) , & if e < {t}_{e} \\ gB ( localLaplacian ( close ( I ) ) ) , & else\end{matrix} , \qquad ( 1 )$$

where I_{b} represents the binary image, I represents the 2D aerial mode image, tₑ represents the first threshold value, e represents the contrast, medianBlur( ) represents median filtering processing, gB( ) represents Gaussian adaptive binarization processing, close( ) represents morphological closing processing, and local Laplacian( ) represents local Laplace filtering processing.

In the underground garage parking space extraction method for high-definition map making according to the embodiment of the disclosure, the operation that the line segment of the binary image is detected and the parking line rotation angle of the parking space is determined according to the detection result includes that: probability Hough transform is performed to detect a line segment set, with a parking line directivity, of the binary image, and the line segment set is traversed to obtain a line segment subset in which a length of each line segment is more than a first threshold value and an included angle between each line segment and a specific direction satisfies a preset condition; and the line segment length and inclination angle in the line segment subset are calculated, and the parking line rotation angle of the parking space is determined according to the line segment length and the inclination angle.

As an implementation, probability Hough transform is performed to detect the line segment set, with the parking line directivity, of the binary image I_{b}, and the line segment set is traversed to obtain the line segment subset in which the line segment length is more than the first threshold value (the first threshold value is represented by, for example, t, t being a positive integer) and the included angle between the line segment and the specific direction meets the preset condition. As an example, the specific direction may be the horizontal direction or the vertical direction. For example, it is the horizontal direction. Then, that the included angle between the line segment and the specific direction meets the preset condition includes that: the included angle between the line segment and the horizontal direction is within a preset threshold value range, namely all line segments in the obtained line segment subset lₖ are line segments of which lengths are more than t and differences of angles of the line segments are relatively small. The line segment length dₖ and inclination angle aₖ in the line segment subset lₖ are calculated, where k represents an index, and the inclination angle aₖ represents the included angle between the line segment and the specific direction, for example, representing the included angle between the line segment and the horizontal direction. Then, a weight coefficient is determined, and the parking line rotation angle is determined according to the weight coefficient. As an example, the weight coefficient may be represented through the following expression:

$${w}_{k} = \frac{{e}^{{d}_{k}}}{{\sum }_{i = 0}^{k} {e}^{{d}_{i}}} .$$

Then, the parking line rotation angle may be represented as θ=wₖaₖ.

In the underground garage parking space extraction method for high-definition map making according to the embodiment of the disclosure, the operation that the binary image is rotated by taking the center point of the binary image as the circle center according to the rotation angle includes that: the binary image is rotated by taking the parking line rotation angle as a rotation angle and taking the center point of the binary image as the circle center, the parking lines in the obtained rotated image being parallel or perpendicular to the horizontal direction.

As an example, the obtained rotated image meets the following expression:

I(x′, y′)ᵣ=((x−x_{c})cos(θ)−(y−y_{c})sin(θ)+x_{c},(x−x_{c})sin(θ)−(y−y_{c})cos(θ)+y_{c}) (2),

where Iᵣ represents the rotated image, I_{b} represents the binary image, (x_{c}, y_{c}) represents the center point of I_{b}, and θ represents the parking line rotation angle. In the embodiment, a 2D coordinate system is established by taking length and width of the image (for example, the binary image) as coordinate axes. In the embodiment, the horizontal direction may be a length direction or width direction of the image.

In the underground garage parking space extraction method for high-definition map making according to the embodiment of the disclosure, the operation that the pixels of the parking lines in each row and each column in the rotated image are counted to obtain the integral projections in the horizontal and vertical directions respectively includes the following operation.

The number of the pixels of the parking lines in each column in the rotated image and the number of the pixels of the parking lines in each row in the rotated image are determined respectively to obtain one-dimensional vector representing the horizontal integral projection and one-dimensional vector representing vertical integral projection respectively. The vector representing the horizontal integral projection may be represented as vᵥ, and the vector representing the vertical integral projection may be represented as vₕ.

In the underground garage parking space extraction method for high-definition map making according to the embodiment of the disclosure, the operation that the coordinates of the four internal angular points of the parking space are obtained by searching according to the integral projection in the horizontal direction and the integral projection in the vertical direction includes that: first elements of which indexes correspond to gray values greater than a second threshold value are searched along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively; and four intersection coordinates corresponding to the parking space in the rotated image are obtained based on the element indexes i, j, m and n.

As an implementation, the first elements of which the indexes correspond to the gray values greater than the second threshold value are searched along the positive and negative directions from the center indexes of the vectors vv and vh to obtain the element vᵥ[i], the element vᵥ[j], the element vₕ[m] and the element vₕ[n] respectively, and the four intersection coordinates (xᵢ, yₘ), (xⱼ, yₘ), (xⱼ, yₙ) and (xᵢ, yₙ) of the parking lines, i.e., the coordinates corresponding to the four internal angular points, in the rotated image Iᵣ are obtained by the element indexes i, j, m and n.

In the underground garage parking space extraction method for high-definition map making according to the embodiment of the disclosure, the operation that the coordinates of the four internal angular points are inversely transformed to point cloud data to extract the parking space includes the following operation.

Inverse rotation transform is performed by taking a center point (x_{c}′, y_{c}′) of the rotated image as a circle center according to the parking space rotation angle to project the coordinates of the four internal angular points to an input point cloud by inverse transform to extract the parking space.

An embodiment of the disclosure also provides an underground garage parking space extraction system for high-definition map making, which includes a projection unit, a contrast estimation unit, an angle estimation unit, a rotation unit, a counting unit, a coordinate searching unit and a parking space extraction unit.

The projection unit is configured to obtain 3D laser point cloud data including a parking space and project the 3D laser point cloud data into a 2D aerial mode image.

The contrast estimation unit is configured to determine a contrast estimate index of the 2D aerial mode image and perform image preprocessing on the 2D aerial mode image according to the contrast estimate index to obtain a binary image.

The angle estimation unit is configured to detect line segments of the binary image and determine a parking line rotation angle of the parking space according to a detection result.

The rotation unit is configured to rotate the binary image by taking a center point of the binary image as a circle center according to the parking line rotation angle to obtain a rotated image.

The counting unit is configured to count pixels of parking lines in each row and pixels of parking lines in each column in the rotated image to obtain integral projections in horizontal and vertical directions respectively.

The coordinate searching unit is configured to obtain coordinates of four internal angular points corresponding to the parking space by searching according to the integral projection in the horizontal direction and the integral projection in the vertical direction.

The parking space extraction unit is configured to inversely transform the coordinates of the four internal angular points to point cloud data to extract the parking space.

In an optional embodiment of the disclosure, the contrast estimation unit is configured to estimate a contrast of the 2D aerial mode image by use of an image standard deviation, the contrast satisfying e=std(I), where I may represent the 2D aerial mode image and e may represent the contrast, compare the contrast and a given threshold value to obtain a comparison result, under the circumstance that the comparison result is that the contrast is less than a first threshold value, sequentially perform median filtering processing, Gaussian adaptive binarization processing and morphological closing processing on the 2D aerial mode image to obtain the binary image, and under the circumstance that the comparison result is that the contrast is more than or equal to the first threshold value, sequentially perform morphological closing processing, local Laplace filtering processing and Gaussian adaptive binarization processing on the 2D aerial mode image to obtain the binary image.

In an optional embodiment of the disclosure, the angle estimation unit is configured to perform probability Hough transform to detect a line segment set, with a parking line directivity, of the binary image, traverse the line segment set to obtain a line segment subset in which a length of each line segment is more than a first threshold value and an included angle between each line segment and a specific direction satisfies a preset condition, calculate the line segment length and inclination angle in the line segment subset and determine the parking line rotation angle of the parking space according to the line segment length and the inclination angle.

In an optional embodiment of the disclosure, the rotation unit is configured to rotate the binary image by taking the parking line rotation angle as a rotation angle and taking the center point of the binary image as the circle center, the parking lines in the obtained rotated image being parallel or perpendicular to the horizontal direction.

In an optional embodiment of the disclosure, the counting unit is configured to determine the number of the pixels of the parking lines in each column in the rotated image and the number of the pixels of the parking lines in each row in the rotated image to obtain one-dimensional vector representing the horizontal integral projection and one-dimensional vector representing vertical integral projection respectively.

In an optional embodiment of the disclosure, the coordinate searching unit is configured to search first elements of which indexes correspond to gray values greater than a second threshold value along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively, and obtain four intersection coordinates corresponding to the parking space in the rotated image based on the element indexes i, j, m and n.

In an optional embodiment of the disclosure, the parking space extraction unit is configured to perform inverse rotation transform by taking a center point of the rotated image as a circle center according to the parking space rotation angle to project the coordinates of the four internal angular points to an input point cloud by inverse transform to extract the parking space.

It is to be noted that the underground garage parking space extraction system for high-definition map making according to the embodiment is described with division of each of the abovementioned program modules as an example during underground garage parking space extraction, and during the practical application, such processing may be allocated to different program modules for completion according to a requirement, namely an internal structure of the system is divided into different program modules to complete all or part of abovementioned processing. In addition, the underground garage parking space extraction system for high-definition map making according to the embodiment belongs to the same concept of the embodiment of the underground garage parking space extraction method for high-definition map making, details about a specific implementation process thereof refer to the method embodiment and elaborations are omitted herein.

An embodiment of the disclosure also provides an underground garage parking space extraction system for high-definition map making, which includes a processor and a memory configured to store a computer program capable of running in the processor, the processor being configured to run the computer program to execute the steps of the method of the embodiments of the disclosure.

It may be understood that the memory may be a volatile memory or a nonvolatile memory, and may also include both the volatile and nonvolatile memories. The nonvolatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, a compact disc or a Compact Disc Read-Only Memory (CD-ROM). The magnetic surface memory may be a disk memory or a tape memory. The volatile memory may be a Random Access Memory (RAM), and is used as an external high-speed cache. It is exemplarily but unlimitedly described that RAMs in various forms may be adopted, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM) and a Direct Rambus Random Access Memory (DRRAM). The memory described in the embodiment of the disclosure is intended to include, but not limited to, memories of these and any other proper types.

The method disclosed in the embodiment of the disclosure may be applied to the processor or implemented by the processor. The processor may be an integrated circuit chip with a signal processing capability. In an implementation process, each step of the method may be completed by an integrated logic circuit of hardware in the processor or an instruction in a software form. The processor 41 may be a universal processor, a Digital Signal Processor (DSP) or another programmable logic device, a discrete gate or transistor logic device, a discrete hardware component and the like. The processor may implement or execute each method, step and logical block diagram disclosed in the embodiments of the disclosure. The universal processor may be a microprocessor, any conventional processor or the like. The steps of the method disclosed in combination with the embodiments of the disclosure may be directly embodied to be executed and completed by a hardware decoding processor or executed and completed by a combination of hardware and software modules in the decoding processor. The software module may be located in a storage medium, and the storage medium is located in the memory. The processor reads information in the memory and completes the steps of the method in combination with hardware.

An embodiment of the disclosure also provides a computer-readable storage medium, in which a computer program is stored, the computer program being executed by a processor to implement the steps of the method of the embodiments of the disclosure.

Compared with a conventional art, implementation of the underground garage parking space extraction method and system for high-definition map making according to the disclosure have the following beneficial effects. The 3D point cloud data is taken as input, the data is obtained by a laser scanner, and the laser scanner is an active light source, so that influence of light is avoided. Different image preprocessing methods are used according to image quality assessments, so that algorithm robustness is improved. The inclination angle in the image is detected by improved probability Hough transform, so that consistency of detection and a detection object is improved. The intersection coordinates of the parking lines are calculated by use of a projected image rotation method to extract the parking space, so that accuracy of extracted parking space data may be effectively ensured, and a requirement on making accuracy of a high-definition map may be met.

In some embodiments provided by the disclosure, it is to be understood that the disclosed system and method may be implemented in another manner. The system embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a RAM, a magnetic disk or a compact disc.

Or, when being implemented in form of software functional module and sold or used as an independent product, the integrated unit of the disclosure may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The storage medium includes: various media capable of storing program codes such as a mobile hard disk, a ROM, a RAM, a magnetic disk or a compact disc.

The above is only the specific implementation of the disclosure and not intended to limit the scope of protection of the application. Any variations or replacements apparent to those skilled in the art within the technical scope disclosed by the disclosure shall fall within the scope of protection of the application. Therefore, the scope of protection of the application shall be subject to the scope of protection of the claims.

1. An underground garage parking space extraction method for high-definition map making, comprising:
obtaining Three-Dimensional (3D) laser point cloud data comprising a parking space, and projecting the 3D laser point cloud data into a Two-Dimensional (2D) aerial mode image;
determining a contrast estimate index of the 2D aerial mode image, and performing image preprocessing on the 2D aerial mode image according to the contrast estimate index to obtain a binary image;
detecting line segments of the binary image, and determining a parking line rotation angle of the parking space according to a detection result;
rotating the binary image by taking a center point of the binary image as a circle center according to the parking line rotation angle to obtain a rotated image;
counting pixels of parking lines in each row and pixels of parking lines in each column in the rotated image to obtain integral projections in horizontal and vertical directions respectively;
obtaining coordinates of four internal angular points corresponding to the parking space by searching according to the integral projections s in the horizontal and vertical directions; and
inversely transforming the coordinates of the four internal angular points to point cloud data to extract the parking space.

2. The underground garage parking space extraction method for high-definition map making of claim 1, wherein determining the contrast estimate index of the 2D aerial mode image and performing image preprocessing on the 2D aerial mode image according to the contrast estimate index to obtain the binary image comprises:
estimating a contrast of the 2D aerial mode image by use of an image standard deviation, the contrast satisfying e=std(I),
where I represents the 2D aerial mode image, and e represents the contrast;
comparing the contrast and a given threshold value to obtain a comparison result;
under the circumstance that the comparison result is that the contrast is less than a first threshold value, sequentially performing median filtering processing, Gaussian adaptive binarization processing and morphological closing processing on the 2D aerial mode image to obtain the binary image; and
under the circumstance that the comparison result is that the contrast is more than or equal to the first threshold value, sequentially performing morphological closing processing, local Laplace filtering processing and Gaussian adaptive binarization processing on the 2D aerial mode image to obtain the binary image.

3. The underground garage parking space extraction method for high-definition map making of claim 1, wherein detecting the line segments of the binary image and determining the parking line rotation angle of the parking space according to the detection result comprises:
performing probability Hough transform to detect a line segment set, with a parking line directivity, of the binary image, and traversing the line segment set to obtain a line segment subset in which a line segment length of each line segment is more than a first threshold value and an included angle between each line segment and a specific direction satisfies a preset condition; and
calculating the line segment length and inclination angle in the line segment subset, and determining the parking line rotation angle of the parking space according to the line segment length and the inclination angle.

4. The underground garage parking space extraction method for high-definition map making of claim 1, wherein rotating the binary image by taking the center point of the binary image as the circle center according to the parking line rotation angle comprises:
rotating the binary image by taking the parking line rotation angle as a rotation angle and taking the center point of the binary image as the circle center, the parking lines in the obtained rotated image being parallel or perpendicular to the horizontal direction.

5. The underground garage parking space extraction method for high-definition map making of claim 1, wherein counting the pixels of the parking lines in each row and each column in the rotated image to obtain the integral projections in the horizontal and vertical directions respectively comprises:
determining the number of the pixels of the parking lines in each column in the rotated image and the number of the pixels of the parking lines in each row in the rotated image to obtain one-dimensional vector representing the horizontal integral projection and one-dimensional vector representing vertical integral projection respectively.

6. The underground garage parking space extraction method for high-definition map making of claim 1, wherein obtaining the coordinates of the four internal angular points of the parking space by searching according to the integral projection in the horizontal direction and the integral projection in the vertical direction comprises:
searching first elements of which indexes correspond to gray values greater than a second threshold value along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively; and
obtaining four intersection coordinates corresponding to the parking space in the rotated image based on the element indexes i, j, m and n.

7. The underground garage parking space extraction method for high-definition map making of claim 1, wherein inversely transforming the coordinates of the four internal angular points to point cloud data to extract the parking space comprises:
performing inverse rotation transform by taking a center point of the rotated image as a circle center according to the parking space rotation angle to project the coordinates of the four internal angular points to an input point cloud by inverse transform to extract the parking space.

8. An underground garage parking space extraction system for high-definition map making, comprising:
a processor; and
a memory configured to store a computer program which is executable on the processor,
wherein the processor is configured to execute the computer program to:
obtain Three-Dimensional (3D) laser point cloud data comprising a parking space and project the 3D laser point cloud data into a Two-Dimensional (2D) aerial mode image;
determine a contrast estimate index of the 2D aerial mode image and perform image preprocessing on the 2D aerial mode image according to the contrast estimate index to obtain a binary image;
detect line segments of the binary image and determine a parking line rotation angle of the parking space according to a detection result;
rotate the binary image by taking a center point of the binary image as a circle center according to the parking line rotation angle to obtain a rotated image;
count pixels of parking lines in each row and pixels of parking lines in each column in the rotated image to obtain integral projections in horizontal and vertical directions respectively;
obtain coordinates of four internal angular points corresponding to the parking space by searching according to the integral projection in the horizontal direction and the integral projection in the vertical direction; and
inversely transform the coordinates of the four internal angular points to point cloud data to extract the parking space.

9. The underground garage parking space extraction system for high-definition map making of claim 8, wherein the processor is configured to execute the computer program to estimate a contrast of the 2D aerial mode image by use of an image standard deviation, the contrast satisfying e=std(I), where I represents the 2D aerial mode image and e represents the contrast, compare the contrast and a given threshold value to obtain a comparison result, under the circumstance that the comparison result is that the contrast is less than a first threshold value, sequentially perform median filtering processing, Gaussian adaptive binarization processing and morphological closing processing on the 2D aerial mode image to obtain the binary image, and under the circumstance that the comparison result is that the contrast is more than or equal to the first threshold value, sequentially perform morphological closing processing, local Laplace filtering processing and Gaussian adaptive binarization processing on the 2D aerial mode image to obtain the binary image.

10. The underground garage parking space extraction system for high-definition map making of claim 8, wherein the processor is configured to execute the computer program to perform probability Hough transform to detect a line segment set, with a parking line directivity, of the binary image, traverse the line segment set to obtain a line segment subset in which a length of each line segment is more than a first threshold value and an included angle between each line segment and a specific direction satisfies a preset condition, calculate the line segment length and inclination angle in the line segment subset and determine the parking line rotation angle of the parking space according to the line segment length and the inclination angle.

11. The underground garage parking space extraction system for high-definition map making of claim 8, wherein the processor is configured to execute the computer program to rotate the binary image by taking the parking line rotation angle as a rotation angle and taking the center point of the binary image as the circle center, the parking lines in the obtained rotated image being parallel or perpendicular to the horizontal direction.

12. The underground garage parking space extraction system for high-definition map making of claim 8, wherein the processor is configured to execute the computer program to determine the number of the pixels of the parking lines in each column in the rotated image and the number of the pixels of the parking lines in each row in the rotated image to obtain one-dimensional vector representing the horizontal integral projection and one-dimensional vector representing vertical integral projection respectively.

13. The underground garage parking space extraction system for high-definition map making of claim 8, wherein the processor is configured to execute the computer program to: search first elements of which indexes correspond to gray values greater than a second threshold value along positive and negative directions from center indexes of the vectors representing the horizontal and vertical integral projections respectively to obtain an element vᵥ[i], an element vᵥ[j], an element vₕ[m] and an element vₕ[n] respectively, i, j, m and n representing the element indexes respectively; and obtain four intersection coordinates corresponding to the parking space in the rotated image based on the element indexes i, j, m and n.

14. The underground garage parking space extraction system for high-definition map making of claim 8, wherein the processor is configured to execute the computer program to perform inverse rotation transform by taking a center point of the rotated image as a circle center according to the parking space rotation angle to project the coordinates of the four internal angular points to an input point cloud by inverse transform to extract the parking space.

15. (canceled)

16. A non-transitory storage medium having stored a computer program, that when being executed by a processor, implement an underground garage parking space extraction method for high-definition map making, the method comprising:
obtaining Three-Dimensional (3D) laser point cloud data comprising a parking space, and projecting the 3D laser point cloud data into a Two-Dimensional (2D) aerial mode image;
determining a contrast estimate index of the 2D aerial mode image, and performing image preprocessing on the 2D aerial mode image according to the contrast estimate index to obtain a binary image;
detecting line segments of the binary image, and determining a parking line rotation angle of the parking space according to a detection result;
rotating the binary image by taking a center point of the binary image as a circle center according to the parking line rotation angle to obtain a rotated image;
counting pixels of parking lines in each row and pixels of parking lines in each column in the rotated image to obtain integral projections in horizontal and vertical directions respectively;
obtaining coordinates of four internal angular points corresponding to the parking space by searching according to the integral projections s in the horizontal and vertical directions; and
inversely transforming the coordinates of the four internal angular points to point cloud data to extract the parking space.

17. The non-transitory storage medium of claim 16, wherein determining the contrast estimate index of the 2D aerial mode image and performing image preprocessing on the 2D aerial mode image according to the contrast estimate index to obtain the binary image comprises:
estimating a contrast of the 2D aerial mode image by use of an image standard deviation, the contrast satisfying e=std(I),
where I represents the 2D aerial mode image, and e represents the contrast;
comparing the contrast and a given threshold value to obtain a comparison result;
under the circumstance that the comparison result is that the contrast is less than a first threshold value, sequentially performing median filtering processing, Gaussian adaptive binarization processing and morphological closing processing on the 2D aerial mode image to obtain the binary image; and
under the circumstance that the comparison result is that the contrast is more than or equal to the first threshold value, sequentially performing morphological closing processing, local Laplace filtering processing and Gaussian adaptive binarization processing on the 2D aerial mode image to obtain the binary image.

18. The non-transitory storage medium of claim 16, wherein detecting the line segments of the binary image and determining the parking line rotation angle of the parking space according to the detection result comprises:
performing probability Hough transform to detect a line segment set, with a parking line directivity, of the binary image, and traversing the line segment set to obtain a line segment subset in which a line segment length of each line segment is more than a first threshold value and an included angle between each line segment and a specific direction satisfies a preset condition; and
calculating the line segment length and inclination angle in the line segment subset, and determining the parking line rotation angle of the parking space according to the line segment length and the inclination angle.

19. The non-transitory storage medium of claim 16, wherein rotating the binary image by taking the center point of the binary image as the circle center according to the parking line rotation angle comprises:
rotating the binary image by taking the parking line rotation angle as a rotation angle and taking the center point of the binary image as the circle center, the parking lines in the obtained rotated image being parallel or perpendicular to the horizontal direction.

20. The non-transitory storage medium of claim 16, wherein counting the pixels of the parking lines in each row and each column in the rotated image to obtain the integral projections in the horizontal and vertical directions respectively comprises:
determining the number of the pixels of the parking lines in each column in the rotated image and the number of the pixels of the parking lines in each row in the rotated image to obtain one-dimensional vector representing the horizontal integral projection and one-dimensional vector representing vertical integral projection respectively.
